(19) United States
(12) Patent Application Publication
(10) Pub. No.: US 2023/0171860 A1
(43) Pub. Date: Jun. 1, 2023

(54) Lamp Control Device, Controllable Color Temperature Lamp and Data Transmission Method

(71) Applicant: Zhongshan DawnSun Electronic Technology Co., Ltd., Zhongshan (CN)

(72) Inventors: Xiaochen CHEN, Zhongshan (CN); Hengjie CHEN, Zhongshan (CN)

(21) Appl. No.: 17/699,343

(22) Filed: Mar. 21, 2022

(30) Foreign Application Priority Data
Nov. 29, 2021 (CN) 202111431715.9

(51) Int. Cl. H05B 45/20; H05B 47/18

(52) U.S. Cl. CPC H05B 45/20; H05B 47/18

(57) ABSTRACT

The present disclosure provides a lamp control device, a controllable color temperature lamp and a data transmission method. The control device includes: a control unit, a switch unit, a rectifying unit, and a light control unit; the control terminal of the switch unit is connected to the output terminal of the control unit; the output terminal of the switch unit is connected to the input terminal of the rectifying unit; the output terminal of the rectifying unit is connected to the detection terminal of the light control unit; the switch unit is provided on the alternating current wire of the lamp.

### CROSS-REFERENCES TO RELATED APPLICATIONS

The present disclosure claims the priority of the Chinese patent application filed with the Chinese Patent Office on Nov. 29, 2021, with the filing number of CN 202111431715.9, entitled as “Lamp Control Device, Controllable Color Temperature Lamp and Data Transmission Method”, the entire contents of which are incorporated into the present disclosure by reference.

### TECHNICAL FIELD

The present disclosure relates to the field of lighting technology, in particular to a lamp control device, a controllable color temperature lamp and a data transmission method.

### BACKGROUND ART

LED (Light Emitting Diode) is a solid-state semiconductor device that can convert electrical energy into visible light, which can directly convert electricity into light. At present, LED lamps have the advantages of low power consumption and long life and the like, and it is gradually becoming a trend to replace traditional lamps with LED lamps.

In the field of LED lighting, thyristors are widely used. The thyristor dimming circuit has simple structure, low cost, convenient use and stronger controllability, and as the market share of LED lamps increases, the thyristor dimming circuit also plays an increasingly important role.

At present, the control circuit of the LED lamp can only adjust the brightness of the LED lamp, but cannot adjust the color temperature, so that the existing LED lamp has a single function and cannot meet the needs of users.

### SUMMARY

In view of this, the purpose of the present disclosure is to provide a lamp control device, a controllable color temperature lamp and a data transmission method, which can adjust the color temperature of the lamp and improve the controllability and applicability of the lamp.

In the first aspect, the present disclosure provides a lamp control device, comprising: a control unit, a switch unit, a rectifying unit, and a light control unit;

the control terminal of the switch unit is connected to the output terminal of the control unit; the output terminal of the switch unit is connected to the input terminal of the rectifying unit; the output terminal of the rectifying unit is connected to the detection terminal of the light control unit; and the switch unit is provided on the alternating current wire of the lamp;

wherein the switch unit is configured to control the conduction (ON) and cut-off of the alternating current inputted to the lamp;

the rectifying unit is configured to convert the alternating current inputted to the lamp into direct current and output the direct current;

the control unit is configured to control the conduction and cut-off of the switch unit;

the light control unit is configured to detect the conduction duration and cut-off time of the direct current outputted by the rectifying unit, and further configured to control a light source according to the conduction duration and cut-off time, so that the light source emits visible light.

In the above, the switch unit is an alternating current semiconductor switch,

wherein the control terminal of the alternating current semiconductor switch is connected to the output terminal of the control unit.

In the above, the alternating current semiconductor switch is a bidirectional thyristor.

In the above, the rectifying unit is a diode-based rectifying circuit,

wherein the positive electrode of the output terminal of the rectifying circuit is connected to the detection terminal of the light control unit.

In the above, the rectifying circuit is a full-bridge rectifying circuit or a half-bridge rectifying circuit.

In the above, the light control unit comprises: a processing module, an extraction module, and a voltage reduction module,

wherein the input terminal of the extraction module is connected to the output terminal of the rectifying unit, and the output terminal of the extraction module is connected to the input terminal of the processing module;

the input terminal of the voltage reduction module is connected to the output terminal of the rectifying unit, and the output terminal of the voltage reduction module is connected to the power supply terminal of the processing module,

wherein the extraction module is configured to extract the voltage and/or current outputted by the rectifying unit, and transmit the extracted voltage and/or current to the processing module;

the voltage reduction module is configured to perform conversion processing on the direct current outputted from the rectifying unit to obtain direct current with a target voltage value; and the target voltage value refers to the voltage value at which the processing module works; and

the processing module detects, through the extraction module, the conduction duration and the cut-off time of the direct current outputted by the rectifying unit.

In the second aspect, the present disclosure provides a controllable color temperature lamp, comprising:

a first color temperature lamp bead, a second color temperature lamp bead, a first control switch, a second control switch, a first galvanostat, a second galvanostat, and a controller;

the first color temperature lamp bead, the first galvanostat, and the first control switch are connected in series to form a first branch circuit; and the second color temperature lamp bead, the second galvanostat, and the second control switch are connected in series to form a second branch circuit;

the control terminal of the first control switch is connected to the first output terminal of the controller; the control terminal of the second control switch is connected to the second output terminal of the controller; the control terminal of the first galvanostat is connected to the third output terminal of the controller; and the control terminal of the second galvanostat is connected to the fourth output terminal of the controller;

two ends of the first branch circuit are respectively connected to the positive electrode and negative electrode of the direct current; and two ends of the second branch circuit are respectively connected to the positive electrode and negative electrode of the direct current,

wherein the first galvanostat is configured to control the magnitude of the current flowing through the first branch circuit, and the second galvanostat is configured to control the magnitude of the current flowing through the second branch circuit;

wherein the color temperature of the first color temperature lamp bead is different from the color temperature of the second color temperature lamp bead, and the controller is the above-mentioned lamp control device.

In the above, the first color temperature lamp bead and the second color temperature lamp bead are both LED lamp beads.

In the above, the first control switch and the second control switch are both switching transistors.

In the third aspect, the present disclosure provides a data transmission method for a controllable color temperature lamp, comprising:

the control unit controlling the conduction duration of the switch unit, to make the switch unit adjust the start time of conduction of an alternating current;

the rectifying unit converting the alternating current into a direct current; and

the light control unit detecting the conduction duration and cut-off time of the direct current, generating load data according to the conduction duration and cut-off time, and generating a control signal according to the load data;

wherein the control signal is used to control the first control switch, the second control switch, and the switch of the first galvanostat or the second galvanostat.

The present disclosure provides a lamp control device, a controllable color temperature lamp and a data transmission method, which can adjust the color temperature of the lamp, improve the controllability and applicability of the lamp, realize the lighting diversity of the lamp, and meet the needs of real life, and has the characteristics of powerful functions and strong applicability.

In order to make the above-mentioned objects, features and advantages of the present disclosure more obvious and understandable, preferred embodiments are described in detail below in conjunction with accompanying drawings.

### BRIEF DESCRIPTION OF DRAWINGS

In order to illustrate the technical solutions in the embodiments of the present disclosure or the prior art more clearly, the drawings that need to be used in the embodiments or the prior art will be briefly introduced below, it should be understood that the following drawings only show some embodiments of the present disclosure, and therefore should not be regarded as a limitation of the scope, and for those ordinary skilled in the art, other relevant drawings can also be obtained in light of these drawings, without using any inventive efforts.

FIG. 1 is a structural schematic view of a lamp control device provided by the present disclosure.

FIG. 2 is a structural schematic view of a light control unit in a lamp control device provided by the present disclosure.

FIG. 3 is a first structural schematic view of a controllable color temperature lamp provided by the present disclosure.

FIG. 4 is a flowchart schematic view of a data transmission method for a controllable color temperature lamp provided by the present disclosure.

### DETAILED DESCRIPTION OF EMBODIMENTS

In order to make the objectives, technical solutions, and advantages of the embodiments of the present disclosure clearer, the technical solutions in the embodiments of the present disclosure will be clearly and completely described below in conjunction with the drawings in the embodiments of the present disclosure, obviously, the described embodiments are only a part of the embodiments of the present disclosure, rather than all of the embodiments. The components of the embodiments of the present disclosure generally described and shown in the drawings herein may be arranged and designed in a variety of different configurations. Therefore, the following detailed description of the embodiments of the present disclosure provided in the drawings is not intended to limit the protection scope of the present disclosure, but merely represents selected embodiments of the present disclosure. Based on the embodiments in the present disclosure, all other embodiments obtained by those skilled in the art without creative work shall fall within the protection scope of the present disclosure.

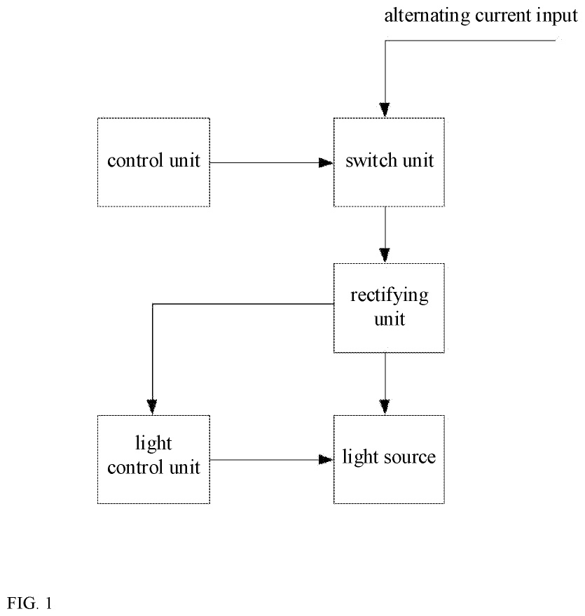

The embodiment of the present disclosure provides a lamp control device, referring to FIG. 1, which specifically includes the following content:

a control unit, a switch unit, a rectifying unit, and a light control unit;

the control terminal of the switch unit is connected to the output terminal of the control unit; the output terminal of the switch unit is connected to the input terminal of the rectifying unit; the output terminal of the rectifying unit is connected to the detection terminal of the light control unit; and the switch unit is provided on the alternating current wire of the lamp;

the switch unit in the present embodiment is configured to control the conduction and cut-off of the alternating current inputted to the lamp;

the rectifying unit is configured to convert the alternating current inputted to the lamp into direct current and output direct current;

the control unit is configured to control the conduction and cut-off of the switch unit;

the light control unit is configured to detect the conduction duration and cut-off time of the direct current outputted by the rectifying unit, and further configured to control the light source according to the conduction duration and cut-off time, so that the light source emits visible light.

In specific implementation, the switch unit is an alternating current semiconductor switch, wherein the control terminal of the alternating current semiconductor switch is connected to the output terminal of the control unit.

Specifically, the alternating current semiconductor switch is a bidirectional thyristor.

The bidirectional thyristor can be widely used in industries, transportation, household appliances and other fields to achieve various functions such as alternating current (AC) switches, automatic turning-on and turning-off of street lights, and stage dimming, is also used in solid-state relays and solid-state contactor circuits, and has the advantages of fast response speed and high stability.

In the present implementation, a bidirectional thyristor is used, which can effectively improve the response speed and stability of the switch unit.

It should be noted that the light control unit in the present embodiment can control the switch unit, and the switch unit controls the conduction and cut-off of the alternating current inputted to the lamp; specifically, the conduction and cut-off of the alternating current inputted into the lamp can be controlled by controlling the conduction duration of the bidirectional thyristor. It can be known that the light control unit allows the bidirectional thyristor to be turned on by applying the trigger voltage to the bidirectional thyristor. Since alternating current is loaded between the cathode and anode of the bidirectional thyristor, when the voltage crosses zero, the bidirectional thyristor may be automatically turned off. During the turn-off period of the bidirectional thyristor, the rectifying unit cannot convert the alternating current into direct current. Therefore, the direct current outputted by the rectifying unit is discontinuous. The light control unit determines the duty cycle of the conduction duration by detecting the conduction duration and cut-off time of the direct current outputted by the rectifying unit; according to the duty cycle, the conduction durations of at least two paths of light sources to be turned on successively are controlled, each path of light source emits visible light of different color temperature, and the visible light of different color temperatures emitted by multiple paths of light sources undergoes color temperature fusion to realize the control and adjustment of the color temperature of the light source.

In the present embodiment, the data can be loaded by adjusting the conduction duration of the bidirectional thyristor, for example, during the positive half cycle of alternating current, the conduction duration is shortened by 100 us; during the negative half cycle of alternating current, the conduction duration is extended by 100 us, then the purpose of loading data one (binary data 1) can be realized. Otherwise, data zero (binary data 0) is loaded. The color temperature of the lamp can be adjusted without affecting the traditional alternating current usage method. In the present embodiment, the alternating current signal is 60 Hz, and the bit rate can reach 60 bps, so it is suitable for most AC electric control scenarios. On the other hand, this method can not only control the color temperature of the lamp, but also has the essence lying in the transmission of the data protocol. Through the data protocol, the diversified control of the lamp can be performed, such as timing light off command, flashing command, periodic color temperature/brightness adjustment command.

It can be seen from the above description that the control device provided in the present embodiment can broaden the control mode of the lamps, so that the lamp solution with chip can perform protocol control, and the IoT applications of various lamps can be completed quickly and conveniently.

In specific implementation, the rectifying unit is a diode-based rectifying circuit, which can be a full-bridge rectifying circuit or a half-bridge rectifying circuit, wherein the positive electrode of the output terminal of the rectifying circuit is connected to the detection terminal of the light control unit.

Specifically, the rectifying circuit is a full-bridge rectifying circuit, which can improve the efficiency of rectification.

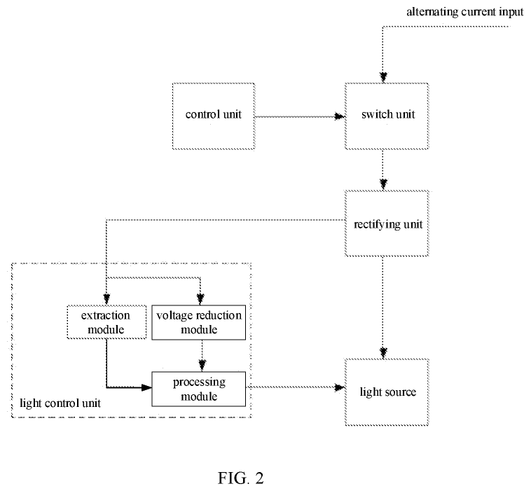

The embodiment provides the specific structure of the light control unit in the above-mentioned embodiment, referring to FIG. 2, which specifically includes the following content:

a processing module, an extraction module, and a voltage reduction module,

wherein the input terminal of the extraction module is connected to the output terminal of the rectifying unit, and the output terminal of the extraction module is connected to the input terminal of the processing module; the input terminal of the voltage reduction module is connected to the output terminal of the rectifying unit, and the output terminal of the voltage reduction module is connected to the power supply terminal of the processing module;

wherein the extraction module is configured to extract the voltage and/or current outputted by the rectifying unit, and transmit the extracted voltage and/or current to the processing module; the voltage reduction module is configured to perform conversion processing on the direct current outputted from the rectifying unit to obtain direct current with a target voltage value; and the target voltage value refers to the voltage value at which the processing module works; and

the processing module detects the conduction duration and the cut-off time of the direct current outputted by the rectifying unit through the extraction module.

It can be understood that the voltage reduction module in this embodiment is a direct current conversion module.

In the present embodiment, the extraction module detects the direct current outputted by the rectifying unit to determine whether the direct current is on or off. In the specific implementation, whether the direct current is on or off can be determined by the conduction of the transistor (triode), which specifically includes: the transistor is on, indicating that it is a closed circuit, which indicates that the direct current is on. On the contrary, if the transistor is not on, it indicates that it is an open circuit, which indicates that the direct current is not on.

In the present embodiment, the processing module is composed of a single chip microcomputer and peripheral circuits thereof. The extraction module transmits the extracted voltage and/or current to the processing module, after the voltage and/or current is divided and shunted by the resistor, it is input to the single chip microcomputer after satisfying the input of the single chip microcomputer. The frequency of detecting receiving of voltage and/or current is determined by the internal clock of the single chip microcomputer, and the conduction duration and the cut-off time of the direct current are determined by means of detecting the receiving of voltage and/or current. For example: detecting whether voltage and/or current input is received every 100 us, and if the voltage and/or current input is detected within all 30 detection cycles, the conduction duration of direct current is 30×100 us. Based on this, the conduction duration and cut-off time of the direct current can be determined, and the duty cycle of the conduction duration can be determined.

It can be seen from the above-mentioned description that a lamp control device and a controllable color temperature lamp proposed in the present disclosure can adjust the color temperature of the lamp, improve the controllability and applicability of the lamp, realize the lighting diversity of the lamp, and meet the needs of real life and has the characteristics of powerful functions and strong applicability.

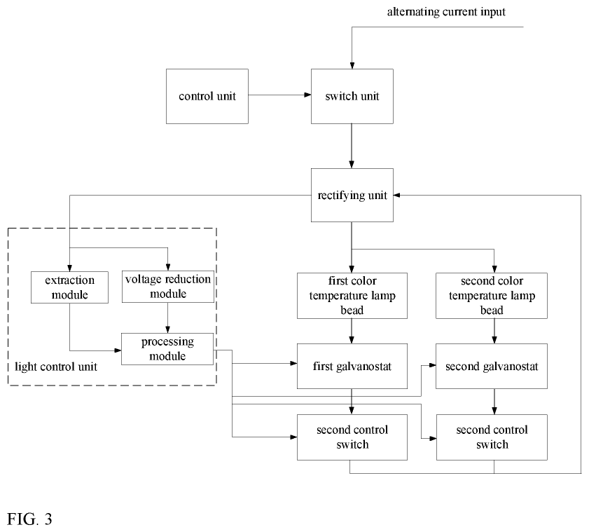

In the embodiment of the present disclosure, a controllable color temperature lamp is provided, referring FIG. 3, which specifically includes the following content:

a first color temperature lamp bead, a second color temperature lamp bead, a first control switch, a second control switch, a first galvanostat, a second galvanostat, and a controller;

the first color temperature lamp bead, the first galvanostat, and the first control switch are connected in series to form a first branch circuit; and the second color temperature lamp bead, the second galvanostat, and the second control switch are connected in series to form a second branch circuit;

the control terminal of the first control switch is connected to the first output terminal of the controller; the control terminal of the second control switch is connected to the second output terminal of the controller; the control terminal of the first galvanostat is connected to the third output terminal of the controller; and the control terminal of the second galvanostat is connected to the fourth output terminal of the controller;

two ends of the first branch circuit are respectively connected to the positive electrode and negative electrode of the direct current; and two ends of the second branch circuit are respectively connected to the positive electrode and negative electrode of the direct current;

wherein the first galvanostat is configured to control the magnitude of the current flowing through the first branch circuit, and the second galvanostat is configured to control the magnitude of current flowing through the second branch circuit;

wherein the color temperature of the first color temperature lamp bead is different from the color temperature of the second color temperature lamp bead, and the controller is the lamp control device in the above-mentioned embodiments.

The first color temperature lamp bead and the second color temperature lamp bead are both LED lamp beads. The first control switch and the second control switch are both switching transistors. The first galvanostat and the second galvanostat are both galvanostat transistors.

In the present embodiment, the controller controls the conduction and cut-off of the two switching transistors respectively, thereby controlling the lighting and extinguishing of the LED lamp beads, so that the LED lamp beads with different color temperatures can emit light, and the color temperature can be controlled.

The controller respectively controls the magnitude of the current on the two galvanostat transistors. By adjusting the magnitude of the current, the LED lamp beads with different color temperatures can emit light of different brightness.

Specifically, the controller can obtain the duty cycle of the conduction duration, for example: 30%. When controlling the two-way LED lamp beads according to the duty cycle, the lighting time of the first color temperature lamp bead can be controlled to account for 30% of a lighting cycle. The lighting time of the second color temperature lamp bead can be controlled to account for 70% of a lighting cycle. Each lighting cycle can be self-designed according to design requirements, for example, 1 ms.

That is, according to the duty cycle, the conduction durations of at least two paths of light sources to be turned on successively are controlled, each path of light source emits visible light of different color temperature, and the visible light of different color temperatures emitted by multiple paths of light sources undergoes color temperature fusion to realize the control and adjustment of the color temperature of the light source.

In the present embodiment, by using a galvanostat instead of a voltage dropping resistor, no matter how the voltage of the power source changes, the LED lamp can constantly obtain a stable working current within the range allowed by the galvanostat, so that the LED lamp emits light stably. The galvanostat in the present embodiment can improve the stability and reliability of the controllable color temperature lamp.

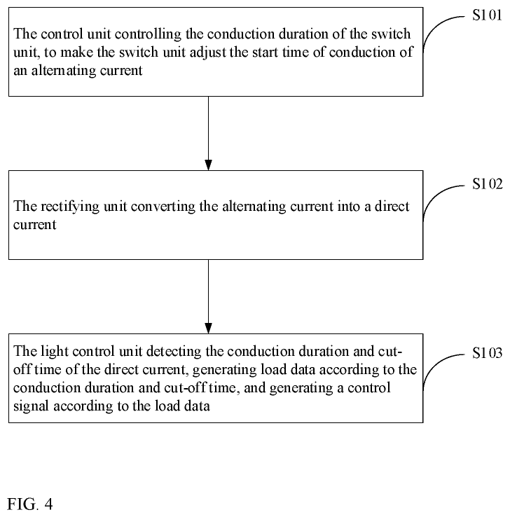

In the embodiment of the present disclosure, a data transmission method based on the controllable color temperature lamp in the above-mentioned embodiments is provided, referring FIG. 4, which specifically includes the following content:

S101: the control unit controlling the conduction duration of the switch unit, to make the switch unit adjust the start time of conduction of an alternating current;

S102: the rectifying unit converting the alternating current into a direct current; and

S103: the light control unit detecting the conduction duration and cut-off time of the direct current, generating load data according to the conduction duration and cut-off time, and generating a control signal according to the load data,

wherein the control signal is used to control the first control switch, the second control switch, and the switch of the first galvanostat or the second galvanostat.

In the present embodiment, the data can be loaded by adjusting the conduction duration of the bidirectional thyristor, for example, during the positive half cycle of alternating current, the conduction duration is shortened by 100 us; during the negative half cycle of alternating current, the conduction duration is extended by 100 us, then the purpose of loading data one (binary data 1) can be realized. Otherwise, data zero (binary data 0) is loaded. The color temperature of the lamp can be adjusted without affecting the traditional alternating current usage method. In the present embodiment, the alternating current signal is 60 Hz, and the bit rate can reach 60 bps, this 60 bps signal can transmit 8 bit data by 133 ms. Therefore, it is suitable for most AC electric control scenarios.

In the present embodiment, the control signals or control protocols that can be transmitted specifically include:

0xF9: change the color to the next gear color temperature according to the preset gear;

0xFB: start of stepless adjustment of color temperature; 0xFD: end of stepless adjustment of color temperature;

0xD3: directly adjust to the preset first gear color temperature;

0xD5: directly adjust to the preset second gear color temperature;

0xD7: directly adjust to the preset third gear color temperature;

0xD9: directly adjust to the preset fourth gear color temperature;

0xDB: directly adjust to the preset fifth gear color temperature;

0xDF: directly adjust to the preset sixth gear color temperature;

0xA5: turn on the light;

0xA9: turn off the light;

0xAB: start of stepless adjustment of brightness;

0xAD: end of stepless adjustment of brightness.

The data transmission method can not only control the color temperature of the lamp, but also has the essence lying in the transmission of the data protocol. Through the data protocol, the diversified control of lamps can be performed, such as timing light off command, flashing command, periodic color temperature/brightness adjustment command.

It can be seen from the above description that the control device provided in the present embodiment can broaden the control mode of the lamps, so that the lamp solution with chip can perform protocol control, and the IoT applications of various lamps can be completed quickly and conveniently.

In the embodiment of the present disclosure, another data transmission method based on the controllable color temperature lamp in the above-mentioned embodiments is also provided, which specifically includes the following content.

By providing a communication module in the light control unit, the communication module sends the external input control signal or control protocol to the light control unit, and the light control unit adjusts the brightness and color temperature of the lamp beads according to the received control signal or control protocol.

It should be noted that the communication module includes but is not limited to RF (Radio Frequency, radio frequency) mode, IoT (Internet of Things, Internet of Things) mode, and Bluetooth mode.

In the embodiments provided by the present disclosure, it should be understood that the disclosed method and device may be implemented in other ways. The device embodiments described above are only schematic. For example, the division of the units is only a logical function division, and there may be other division modes in actual implementation. For another example, multiple units or components can be combined or integrated into another system, or some features can be ignored, or do not be executed. In addition, the displayed or discussed mutual couplings or direct couplings or communication connections may be indirect couplings or communication of devices or units through some communication interfaces, and may be in electrical, mechanical or other forms.

The units described as separate components may or may not be physically separated, and the displayed components as units may or may not be physical units, that is, they may be located in one place, or may be distributed on multiple network units. Some or all of the units may be selected according to actual needs to achieve the objective of the solution of the present embodiment.

In addition, the functional units in the embodiments provided by the present disclosure may be integrated into one processing unit, or each unit may exist separately physically, or two or more units may be integrated into one unit.

In this article, relational terms such as first and second are only used to distinguish one entity or operation from another entity or operation, and do not necessarily require or imply the existence on any such actual relationship or order between these entities or operations. Moreover, the terms “include”, “contain” or any other variants thereof are intended to cover non-exclusive contain, so that a process, method, article, or device that includes a series of elements includes not only those elements, but also other elements that are not explicitly listed, or also include elements inherent to this process, method, article or device. If there are no more restrictions, the element defined by the sentence “including a . . . ” does not exclude that there are other identical elements in the process, method, article, or device including the elements. Unless otherwise definitely specified and limited, the terms “mount”, “link” and “connect” should be understood in a broad sense, for example, they can be fixed connection, detachable connection or integrated connection; they can be mechanical connection or electrical connection; they can be direct connection or indirect connection by intermediate medium, they may be internal communication between two components. For those ordinarily skilled in the art, the specific meaning of the above terms in the present disclosure can be understood according to the specific situation.

It should be noted that the embodiments of the present disclosure and the features in the embodiments can be combined with each other if there is no conflict. The present disclosure is not limited to any single aspect, nor to any single embodiment, nor to any combination and/or replacement of these aspects and/or embodiments. Moreover, each aspect and/or embodiment of the present disclosure may be used separately or in combination with one or more other aspects and/or embodiments thereof.

Finally, it should be noted that the above-mentioned embodiments are only specific embodiments of the present disclosure, which are used to illustrate the technical solutions of the present disclosure, but not to limit them, the protection scope of the present disclosure is not limited thereto, although the present disclosure has been described in detail with reference to the foregoing embodiments, those ordinary skilled in the art should understand: anyone familiar with the technical field within the technical scope disclosed in the present disclosure can still modify or easily think of changes to the technical solutions described in the foregoing embodiments, or equivalently replace some of the technical features; however, these modifications, changes or replacements do not make the essence of the corresponding technical solutions to deviate from the spirit and scope of the technical solutions of the embodiments of the present disclosure. All should be covered within the protection scope of the present disclosure. Therefore, the protection scope of the present disclosure should be subject to the protection scope of the claims.

What is claimed is:

1. A lamp control device, comprising: a control unit, a switch unit, a rectifying unit, and a light control unit,
wherein a control terminal of the switch unit is connected to an output terminal of the control unit, an output terminal of the switch unit is connected to an input terminal of the rectifying unit, an output terminal of the rectifying unit is connected to a detection terminal of the light control unit, and the switch unit is provided on an alternating current wire of a lamp;
wherein the switch unit is configured to control conduction and cut-off of the alternating current inputted to the lamp;
the rectifying unit is configured to convert the alternating current inputted to the lamp into a direct current and output the direct current;
the control unit is configured to control conduction and cut-off of the switch unit; and
the light control unit is configured to detect conduction duration and cut-off time of the direct current outputted by the rectifying unit, and further configured to control the light source according to the conduction duration and cut-off time, to make the light source emit visible light.

2. The lamp control device according to claim 1, wherein the switch unit is an alternating current semiconductor switch; and
wherein a control terminal of the alternating current semiconductor switch is connected to the output terminal of the control unit.

3. The lamp control device according to claim 2, wherein the alternating current semiconductor switch is a bidirectional thyristor.

4. The lamp control device according to claim 1, wherein the rectifying unit is a diode-based rectifying circuit; and
wherein a positive electrode of the output terminal of the rectifying circuit is connected to the detection terminal of the light control unit.

5. The lamp control device according to claim 4, wherein the rectifying circuit is a full-bridge rectifying circuit or a half-bridge rectifying circuit.

6. The lamp control device according to claim 1, wherein the light control unit comprises:
a processing module, an extraction module, and a voltage reduction module,
wherein an input terminal of the extraction module is connected to the output terminal of the rectifying unit, and an output terminal of the extraction module is connected to an input terminal of the processing module;
an input terminal of the voltage reduction module is connected to the output terminal of the rectifying unit, and an output terminal of the voltage reduction module is connected to a power supply terminal of the processing module;
wherein the extraction module is configured to extract a voltage and/or current outputted by the rectifying unit, and transmit the extracted voltage and/or current to the processing module;
the voltage reduction module is configured to perform conversion processing on the direct current outputted from the rectifying unit to obtain a direct current with a target voltage value, wherein the target voltage value refers to a voltage value at which the processing module works; and
the processing module is configured to detect the conduction duration and the cut-off time of the direct current outputted by the rectifying unit through the extraction module.

7. A controllable color temperature lamp, comprising: a first color temperature lamp bead, a second color temperature lamp bead, a first control switch, a second control switch, a first galvanostat, a second galvanostat, and a controller,
wherein the first color temperature lamp bead, the first galvanostat, and the first control switch are connected in series to form a first branch circuit; and the second color temperature lamp bead, the second galvanostat, and the second control switch are connected in series to form a second branch circuit;
a control terminal of the first control switch is connected to a first output terminal of the controller; a control terminal of the second control switch is connected to a second output terminal of the controller; a control terminal of the first galvanostat is connected to a third output terminal of the controller; and a control terminal of the second galvanostat is connected to a fourth output terminal of the controller;
two ends of the first branch circuit are respectively connected to a positive electrode and a negative electrode of a direct current, and two ends of the second branch circuit are respectively connected to the positive electrode and the negative electrode of the direct current;
wherein the first galvanostat is configured to control magnitude of a current flowing through the first branch circuit, and the second galvanostat is configured to control magnitude of a current flowing through the second branch circuit;
wherein a color temperature of the first color temperature lamp bead is different from a color temperature of the second color temperature lamp bead, and the controller is the lamp control device according to claim 1.

8. The controllable color temperature lamp according to claim 7, wherein the first color temperature lamp bead and the second color temperature lamp bead are both LED lamp beads.

9. The controllable color temperature lamp according to claim 7, wherein the first control switch and the second control switch are both switching transistors.

10. A data transmission method based on the controllable color temperature lamp of claim 7, comprising:
the control unit controlling conduction duration of the switch unit, to make the switch unit adjust a start time of conduction of an alternating current;
the rectifying unit converting the alternating current into a direct current; and
the light control unit detecting conduction duration and cut-off time of the direct current, generating load data according to the conduction duration and the cut-off time, and generating a control signal according to the load data,
wherein the control signal is used to control the first control switch, the second control switch, and a switch of the first galvanostat or the second galvanostat.

11. The controllable color temperature lamp according to claim 7, wherein the switch unit is an alternating current semiconductor switch; and
wherein a control terminal of the alternating current semiconductor switch is connected to the output terminal of the control unit.

12. The controllable color temperature lamp according to claim 11, wherein the alternating current semiconductor switch is a bidirectional thyristor.

13. The controllable color temperature lamp according to claim 7, wherein the rectifying unit is a diode-based rectifying circuit; and
wherein a positive electrode of the output terminal of the rectifying circuit is connected to the detection terminal of the light control unit.

14. The controllable color temperature lamp according to claim 13, wherein the rectifying circuit is a full-bridge rectifying circuit or a half-bridge rectifying circuit.

15. The controllable color temperature lamp according to claim 7, wherein the light control unit comprises: a processing module, an extraction module, and a voltage reduction module,
wherein an input terminal of the extraction module is connected to the output terminal of the rectifying unit, and an output terminal of the extraction module is connected to an input terminal of the processing module;
an input terminal of the voltage reduction module is connected to the output terminal of the rectifying unit, and an output terminal of the voltage reduction module is connected to a power supply terminal of the processing module;
wherein the extraction module is configured to extract a voltage and/or current outputted by the rectifying unit, and transmit the extracted voltage and/or current to the processing module;
the voltage reduction module is configured to perform conversion processing on the direct current outputted from the rectifying unit to obtain a direct current with a target voltage value, wherein the target voltage value refers to a voltage value at which the processing module works; and
the processing module is configured to detect the conduction duration and the cut-off time of the direct current outputted by the rectifying unit through the extraction module.
